(19) United States
(12) Patent Application Publication
(10) Pub. No.: US 2011/0035946 A1
(43) Pub. Date: Feb. 17, 2011

(54) COMBINATION EATING UTENSIL

(75) Inventor: Andrew MENCELES, Toronto (CA)

Correspondence Address: SIMPSON & SIMPSON, PLLC, 5555 MAIN STREET, WILLIAMSVILLE, NY, 14221-5406, US

(73) Assignee: Gabi Concepts Ltd., Toronto (CA)

(21) Appl. No.: 12/539,514

(22) Filed: Aug. 11, 2009

(51) Int. Cl. A47J 43/28; B65D 30/00

(52) U.S. Cl. 30/147; 383/127

(57) ABSTRACT

A combination eating utensil including a spoon having a bowl extending from a first handle, wherein the first handle includes a first distal end arranged opposite the bowl and having an overhang, and a first upper surface comprising a protuberance having a lip; and, a fork having a plurality of tines extending from a second handle, wherein the second handle includes a second distal end arranged opposite the plurality of tines and a second upper surface comprising a member having a groove adapted to interlock with the lip, wherein the second distal end is adapted to be inserted underneath the overhang, the spoon is removably secured to the second utensil when the groove is interlocked with the lip, and the groove is arranged to pivot toward and interlock with the lip.

### FIELD OF THE INVENTION

The invention relates to eating utensils, and particularly to combination eating utensils.

### BACKGROUND OF THE INVENTION

Combination eating utensils are well known. Generally, combination eating utensils comprise a plurality of operative structures, where each operative structure of the plurality of operative structures is formed to manipulate food. These operative structures may be combined on the same utensil or on a plurality of utensils that can be removably secured to each other. The operative structures can take many forms, but generally adhere to the forms of conventional eating utensils. A concave surface can be used as a spoon. A plurality of tines can be used as a fork. A honed or serrated edge can be used as knife. These operative structures are arranged on further structure that functions as a handle which a user can grasp to manipulate the combination eating utensil.

One problem with prior combination eating utensils is that the manner of removably securing the utensils prevents water or food from escaping the combined utensil. Combination eating utensils that slidingly engage generally press against each other, trapping water and any food residue between the opposing surfaces. Utensils that snap or nest together may similarly trap water or food between opposing surfaces or in closed cavities formed by the combined utensils. The tendency of prior combination eating utensils to trap water and food encourages microbial growth and compromises hygiene.

Another problem common in prior combination eating utensils is their inability to be easily separated. Combination eating utensils must necessarily be secured with a mechanism to prevent inadvertent separation. The magnitude or direction of the force required to overcome this mechanism can be beyond what a single hand is capable of exerting. Commonly, the user of the combination eating utensil must grasp one portion with one hand and another portion with their other hand in order to separate the individual utensils. This is obviously inconvenient in situations where the user only has one available hand with which to operate the combination eating utensil.

A further problem with prior combination eating utensils is that the mechanism used to removably secure the individual utensils may operate in such a way as to preclude attaching each of the individual utensils, through apertures therein, on a loop of string or chain. For example, combination eating utensils with individual utensils that slidingly engage will necessarily shear against any string or chain threaded through the individual utensils. This contact with the string or chain can prevent separation by jamming the securing mechanism, or it can even damage the string or chain.

Still another problem with prior combination eating utensils is their lack of utility when the individual utensils are removably secured to each other. Specifically, the removably secured combination of the individual utensils does not form an independently useful device.

Another problem with prior combination eating utensils is that they frequently sacrifice ergonomics for compactness or aesthetics. For example, a combination eating utensil may have a compact, but uncomfortable handle.

Thus, there is a long-felt need for a combination eating utensil which does not trap water or food residue. There is also a long-felt need for a combination eating utensil which is easy to separate into its individual utensils, and which does not preclude attaching on a loop of string or chain. Finally, there is a long-felt need for a combination eating utensil which is ergonomic and has utility when it is in its combined state.

### SUMMARY OF THE INVENTION

Generally, the present invention is a combination eating utensil comprising: a first utensil having a first means for holding food extending from a first handle, wherein the first handle includes a first distal end arranged opposite the first means for holding food and a first upper surface having a first locking element; and, a second utensil having a second means for holding food extending from a second handle, wherein the second handle includes a second distal end arranged opposite the second means for holding food and a second upper surface having a second locking element adapted to removably secure the first utensil to the second utensil when engaged with the first locking element, wherein the second distal end is adapted to be removably secured to the first distal end and pivotably connect the first utensil to the second utensil, and the second locking element is arranged to pivot toward and engage the first locking element when the first utensil is pivotably connected to the second utensil.

In one embodiment, the aforementioned combination eating utensil is part of a meal transport system comprising: a spoon having a bowl extending from a first handle, wherein the first handle includes a first distal end arranged opposite the bowl and having an overhang, and a first upper surface comprising a protuberance having a lip; and, a fork having a plurality of tines extending from a second handle, wherein the second handle includes a second distal end arranged opposite the plurality of tines and a second upper surface comprising a member having a groove adapted to interlock with the lip, wherein the second distal end is adapted is adapted to be inserted underneath the overhang, and the spoon is pivotably connected to the fork when second distal end is inserted underneath the overhang, the spoon is removably secured to the second utensil when the groove is interlocked with the lip, and the groove is arranged to pivot toward and interlock with the lip when the first utensil is pivotably connected to the second utensil.

A general object of the invention is to provide a combination eating utensil which does not trap water and food when in a combined state.

Another object of the invention is to provide a combination eating utensil which can easily be separated into its component utensils, especially when attached to a length string or chain.

A further object of the invention is to provide combination eating utensil which can easily store items therein.

Further advantages, features and details of the invention are found in the following description in which an exemplary embodiment is described in detail with reference to the drawing, whereby the features mentioned in the claims and in the description can be essential to the invention individually or in any desired combination.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the present invention combination eating utensil comprising a first utensil and a second utensil;

FIG. 2 is a top plan view of the first utensil;

FIG. 3 is a bottom plan view of the first utensil;

FIG. 4 is a top plan view of the second utensil;

FIG. 5 is a bottom plan view of the second utensil;

FIG. 6 is a top plan view of the combination eating utensil;

FIG. 7 is a cross-sectional view of the combination eating utensil taken generally along line 7-7 in FIG. 6, shown holding an item therein;

FIG. 8A is a cross-sectional view taken generally along line 8-8 in FIG. 6, shown with the first utensil and detached from the second utensil;

FIG. 8B is a cross-sectional view taken generally along line 8-8 in FIG. 6, shown with the first utensil pivotably connected to the second utensil;

FIG. 8C is a cross-sectional view taken generally along line 8-8 in FIG. 6, shown with the first utensil removably secured to the second utensil; and,

FIG. 9 is a perspective view of a present invention meal transport system.

### DETAILED DESCRIPTION OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that the invention is not limited to the particular methodology, materials, and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the terms “front”, “back”, “left”, and “right”, when used herein, are relative terms meant to refer to the viewing perspective of the figures.

Although many methods, devices or materials similar or equivalent to those described herein can be used in the practice or testing of the invention, the preferred methods, devices, and materials are now described.

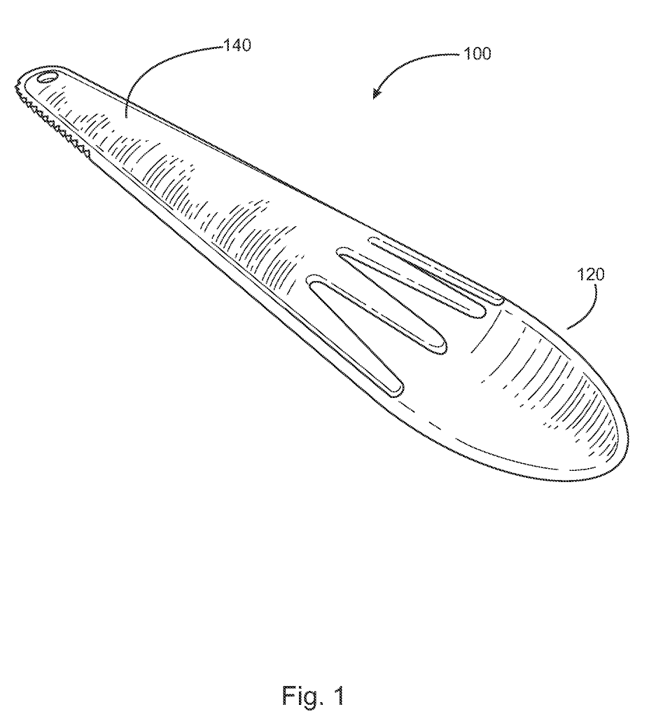

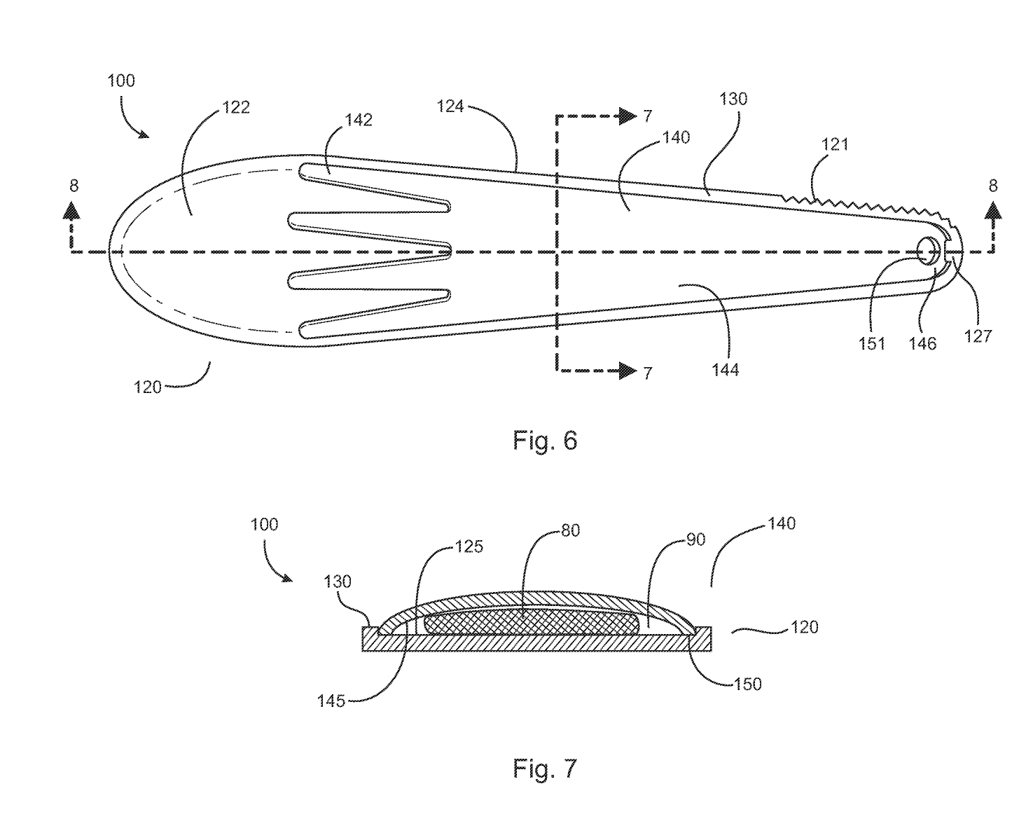

The following description is best understood in view of FIGS. 1-9, which show an exemplary embodiment of the present invention combination eating utensil, hereinafter referred to as combination utensil 100. As illustrated in FIG. 1, combination utensil 100 broadly comprises first utensil 120 and second utensil 140, shown removably secured to each other.

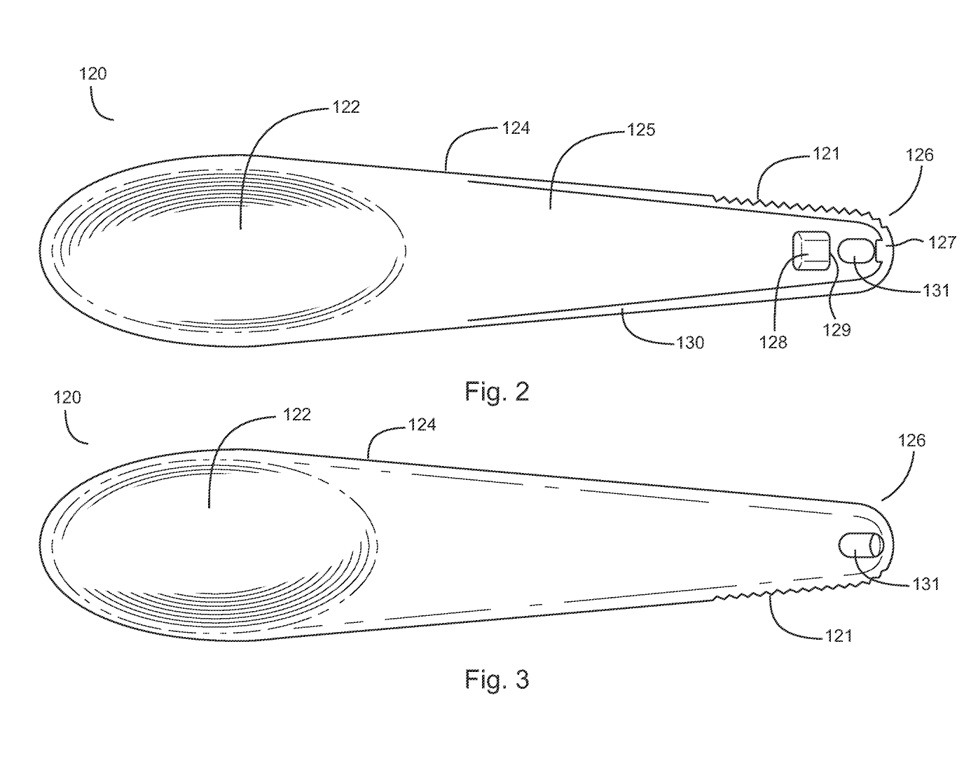

As shown in FIGS. 2 and 3, first utensil 120 includes a first means for holding food extending from first handle 124. It should be appreciated that the first means for holding food can be any means known in the art, for example, a plurality of tines, a blade, a shallow bowl, etc. In the embodiment shown in the figures, the first means for holding food comprises bowl 122. Thus, in this embodiment, first utensil 120 can be considered a spoon.

First handle 124 includes first distal end 126, arranged opposite bowl 122 and comprising overhang 127, and first upper surface 125 having at least one first locking element. In one embodiment, as shown in the figures, first upper surface 125 includes a perimeter and ridge 130 extending upwardly therefrom. Ridge 130 is arranged to fittingly receive and surround a rim of second utensil 140 when first utensil 120 is removably secured thereto. Additionally, first handle 120 may include serrated edge 121, which is adapted to cut foodstuffs similar. Thus, first utensil 120 may also serve as knife when gripped about the first means for holding food.

The first locking element is adapted to engage with a second locking element arranged on the second utensil and, thereby, removably secure the first utensil to the second utensil. In the embodiment shown in the figures, the first utensil comprises what can be considered two first locking elements, each of which is adapted to engage one of two second locking elements arranged on the second utensil and, thereby, remvoably secure the first utensil to the second utensil. While only one these first locking elements is necessary for removably securing the first utensil to the second utensil, in a preferred embodiment, both are included in order to augment the removable connection between the first and second utensils.

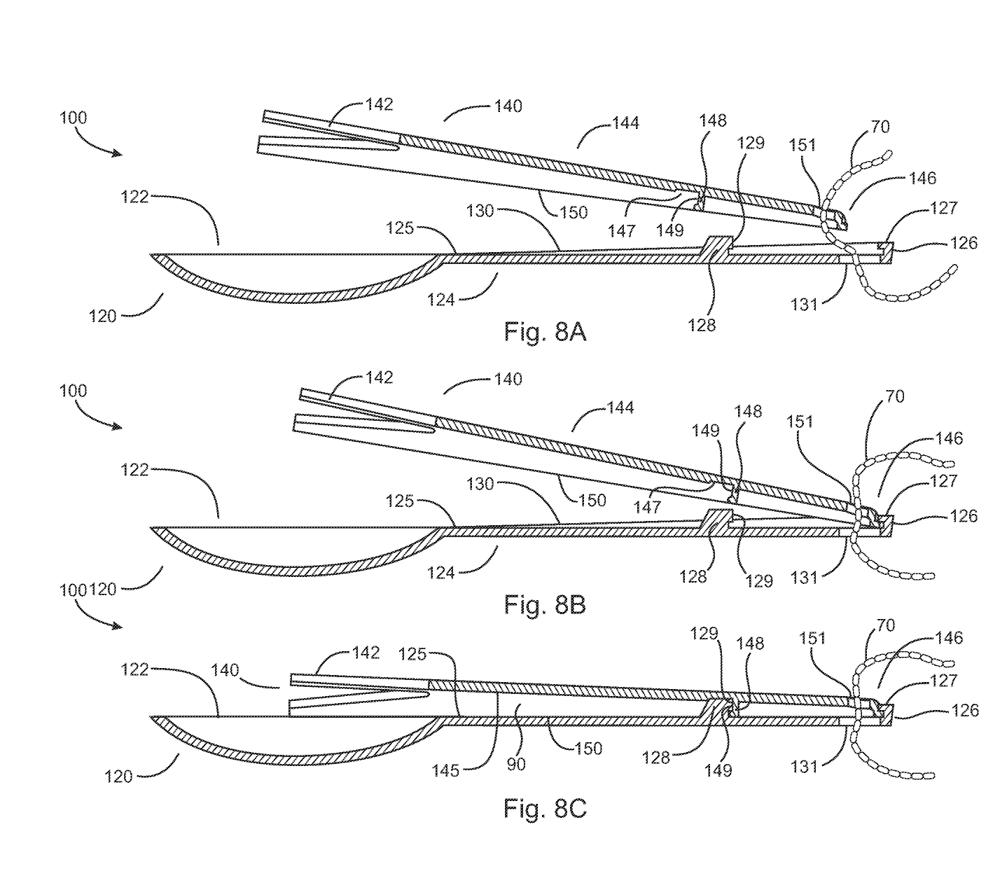

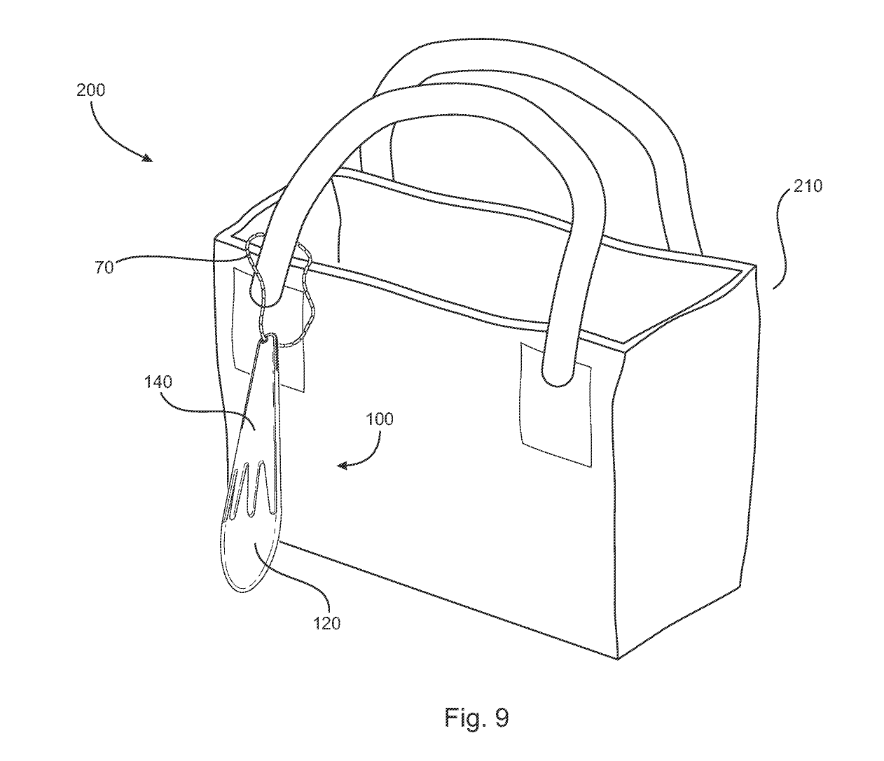

In particular, one first locking element comprises lip 129 extending from protuberance 128 over first upper surface 125. As shown in FIGS. 8A-8C, lip 129 is adapted to engage a second locking element arranged on second utensil 140 and removably secure first utensil 120 to second utensil 140. Protuberance 128 serves as another first locking element, as it is adapted to engage another second locking element arranged on second utensil 140 and removably secure first utensil 120 to second utensil 140. As stated above, either lip 129 or protuberance 128 is capable of serving as the first locking element, but both are included in a preferred embodiment in order to augment the removable connection between the first and second utensils.

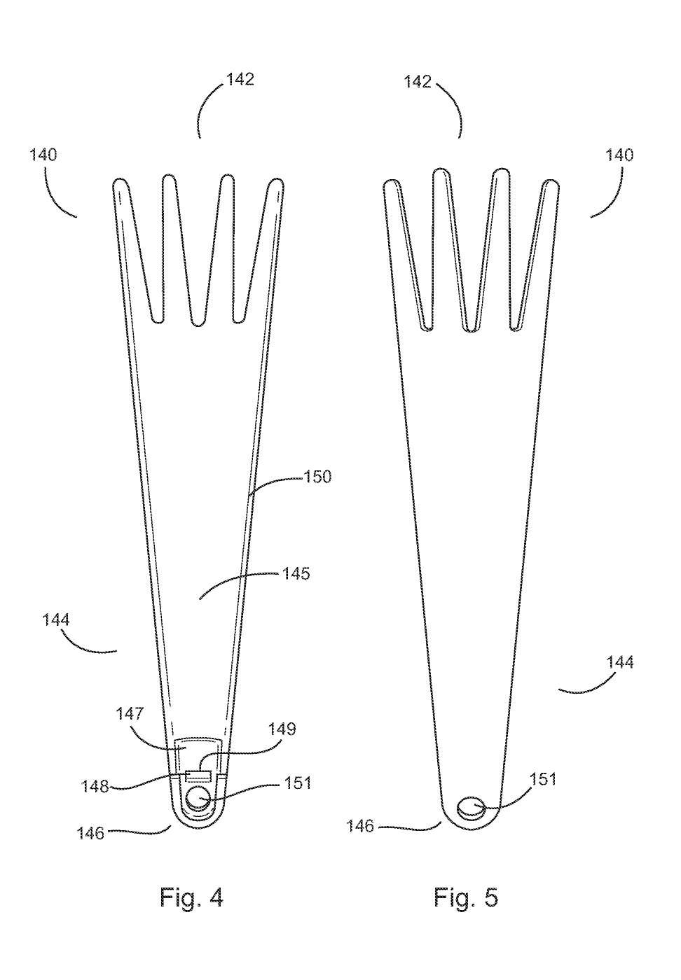

As shown in FIGS. 4 and 5, second utensil 140 comprises a second means for holding food extending from second handle 144. It should be appreciated that the second means for holding food can be any means known in the art, for example, a plurality of tines, a blade, a shallow bowl, etc. In the embodiment shown in the figures, the second means for holding food comprises a plurality of tines 142. Thus, in this embodiment, second utensil 140 can be considered a fork.

Second handle 144 includes second distal end 146, arranged opposite tines 142, and second upper surface 145 having at least one second locking element adapted to removably secure first utensil 120 to second utensil 140 when engaged with a first locking element. In one embodiment, as shown in the figures, second upper surface 145 is concave and includes rim 150 provided by the edge of second handle 144. As stated above, ridge 130 ridge is arranged to fittingly receive and surround rim 150 when the first utensil is removably secured to the second utensil.

A concave second upper surface 145 is particularly advantageous for a number of reasons. For example, it mitigates the amount of surface-to-surface contact between the first and second utensils, thereby, reducing the likelihood of water or particulate matter from foodstuffs becoming trapped in the combination utensil. Additionally, first upper surface 125 and second upper surface 145 together form cavity 90, which may be used to store items, such as, ketchup packet 80 shown in FIG. 7. Moreover, since first utensil 120 and second utensil 140 are removably connectable at their respective distal ends, 126 and 146, and arranged to pivot toward each other, ultimately, into a closed position in which cavity 90 is formed, a user may easily determine whether the item she wishes to store is too big for the cavity, for example, if the item prevents the first locking element from engaging the second locking element, and such determination can be performed without damaging the item.

The second locking element is adapted to engage with a first locking element arranged on the first utensil and, thereby, removably secure the first utensil to the second utensil. In the embodiment shown in the figures, the second utensil comprises what can be considered two second locking elements, each of which is adapted to engage one of two first locking elements arranged on the first utensil and, thereby, removably secure the first utensil to the second utensil. While only one these second locking elements is necessary for removably securing the first utensil to the second utensil, in a preferred embodiment, both are included in order to augment the removable connection between the first and second utensils.

In particular, one second locking element comprises member 148 extending from second upper surface 145 and having groove 149 adapted to interlock with lip 129. As illustrated in FIGS. 8A-8C, first utensil 120 is removably secured to second utensil 140 when groove 149 is interlocked with lip 129. Second upper surface 145 may include recess 147, which serves as another second locking element, as it is adapted to engage and form a friction fit with protuberance 128 when inserted therein, and thereby removably secure first utensil 120 to second utensil 140. As stated above, either groove 149 or recess 147 is capable of serving as the second locking element, but both are included in a preferred embodiment in order to augment the removable connection between the first and second utensils.

Second distal end 146 is adapted to be removably secured to first distal end 126 such that first utensil 120 is pivotably connected to second utensil 140. In the embodiment shown in the figures, particularly in FIG. 8B, second distal end 146 is so adapted by being thin enough to be inserted underneath overhang 127, as illustrated with the arrow in FIG. 8A, thus forming a second class lever or hinge, as shown in FIG. 8B. When first utensil 120 is pivotably connected to second utensil 120, the second locking elements are arranged to pivot toward their complimentary first locking elements, as illustrated with the curved, double-headed arrow in FIG. 8B, and ultimately engage their complimentary first locking elements, as illustrated in FIG. 8C, which shows lip 129 interlocked with groove 149 and protuberance 128 inserted in recess 147.

In the embodiment shown in the figures, ridge 130 ridge, being arranged to fittingly receive and surround rim 150, is thus adapted to guide second utensil 140 into the correct position relative to first utensil 120 and, thereby, help guide the second locking elements toward their respective first locking elements for proper engagement, as well as help secure the first and second utensils once removably secured to each other.

In a preferred embodiment, as shown in the figures, first handle 124 includes first aperture 131 arranged proximate first distal end 126, second handle 144 includes second aperture 151 arranged proximate second distal end 146, and first aperture 131 is aligned with second aperture 151 when first utensil 120 is removably secured to second utensil 140. This aspect is particularly advantageous as it allows a user to carry the components of combination utensil 100 on a length of deformable material, such as chain 70, which extends through first and second apertures, 131 and 151, as shown in FIGS. 8A-9. Moreover, since first utensil 120 and second utensil 140 are arranged to pivot toward and away from each other along the same general path of the chain, a user may disconnect them for use and reconnect them afterward while they are still on the chain, as shown in the figures.

Additionally, in the embodiment shown in FIG. 9, combination eating utensil 100 is part of meal transport system 200. Meal transport system 200 comprises bag 210, which is preferably thermally insulated and adapted to store food items therein, a length of deformable of material attached to the bag, namely, chain 70, and combination utensil 100. Chain 70 is formed as a loop and extends through first aperture 131 and second aperture 151 such that the combination utensil 100 hangs from the bag. This arrangement is particularly advantageous as it exposes combination utensil 100 to a flow of air as a user carries bag 210, thereby effectively drying combination utensil 100 after its use. In this embodiment, second upper surface 145 is preferably concave and includes rim 150 provided by the edge of second handle 144, in order to provide air access to cavity 90, thereby allowing combination utensil 100 to effectively dry and release any particulate matter left thereon after use, as described above.

Thus it is seen that the objects of the invention are efficiently obtained, although changes and modifications to the invention should be readily apparent to those having ordinary skill in the art, which changes would not depart from the spirit and scope of the invention as claimed.

What I claim is:

1. A combination eating utensil comprising:
a first utensil having a first means for holding food extending from a first handle, wherein the first handle includes a first distal end arranged opposite the first means for holding food and a first upper surface having a first locking element; and,
a second utensil having a second means for holding food extending from a second handle, wherein the second handle includes a second distal end arranged opposite the second means for holding food and a second upper surface having a second locking element adapted to removably secure the first utensil to the second utensil when engaged with the first locking element, wherein the second distal end is adapted to be removably secured to the first distal end and pivotably connect the first utensil to the second utensil, and the second locking element is arranged to pivot toward and engage the first locking element when the first utensil is pivotably connected to the second utensil.

2. The combination eating utensil recited in claim 1 wherein the first distal end comprises an overhang, the second distal end is adapted to be inserted underneath the overhang, and the first utensil is pivotably connected to the second utensil when second distal end is inserted underneath the overhang.

3. The combination eating utensil recited in claim 1 wherein the first locking element comprises a lip extending over the first upper surface, the second locking element comprises a member extending from the second upper surface and having a groove adapted to interlock with the lip, and the first utensil is removably secured to the second utensil when the groove is interlocked with the lip.

4. The combination eating utensil recited in claim 3 wherein the first upper surface comprises a protuberance, and the second upper surface comprises a recess adapted to form a friction fit with the protuberance when the protuberance is inserted therein.

5. The combination eating utensil recited in claim 1 wherein the first locking element comprises a protuberance arranged on the first upper surface, the second locking element comprises a recess arranged in the second upper surface and adapted to form a friction fit with the protuberance when the protuberance is inserted therein, and the first utensil is removably secured to the second utensil when the protuberance is inserted within the recess.

6. The combination eating utensil recited in claim 5 wherein the first upper surface comprises a lip, and the second upper surface comprises a member having a groove adapted to interlock with the lip.

7. The combination eating utensil recited in claim 1 wherein the second upper surface is concave and includes a rim, the first upper surface includes a perimeter and a ridge extending upwardly therefrom, and the ridge is arranged to fittingly receive and surround the rim when the first utensil is removably secured to the second utensil.

8. The combination eating utensil recited in claim 3 wherein the second upper surface is concave and includes a rim, the first upper surface includes a perimeter and a ridge extending upwardly therefrom, and the ridge is arranged to fittingly receive and surround the rim when the first utensil is removably secured to the second utensil.

9. The combination eating utensil recited in claim 5 wherein the second upper surface is concave and includes a rim, the first upper surface includes a perimeter and a ridge extending upwardly therefrom, and the ridge is arranged to fittingly receive and surround the rim when the first utensil is removably secured to the second utensil.

10. The combination eating utensil recited in claim 1 wherein the first means for holding food comprises a plurality of tines or a bowl.

11. The combination eating utensil recited in claim 1 wherein the second means for holding food comprises a plurality of tines or a bowl.

12. The combination eating utensil recited in claim 1 wherein the first handle includes a serrated edge.

13. The combination eating utensil recited in claim 1 wherein the first handle includes a first aperture arranged proximate the first distal end, the second handle includes a second aperture arranged proximate the second distal end, and the first aperture is aligned with the second aperture when the first utensil is removably secured to the second utensil.

14. A combination eating utensil comprising:
a spoon having a bowl extending from a first handle, wherein the first handle includes a first distal end arranged opposite the bowl and having an overhang, and a first upper surface comprising a protuberance having a lip; and,
a fork having a plurality of tines extending from a second handle, wherein the second handle includes a second distal end arranged opposite the plurality of tines and a second upper surface comprising a member having a groove adapted to interlock with the lip, wherein the second distal end is adapted to be inserted underneath the overhang, and the spoon is pivotably connected to the fork when second distal end is inserted underneath the overhang, the spoon is removably secured to the second utensil when the groove is interlocked with the lip, and the groove is arranged to pivot toward and interlock with the lip when the first utensil is pivotably connected to the second utensil.

15. The combination eating utensil recited in claim 14 wherein the upper surface further comprises a recess adapted to form a friction fit with the protuberance.

16. The combination eating utensil recited in claim 14 wherein the second upper surface is concave and includes a rim, the first upper surface includes a perimeter and a ridge extending upwardly therefrom, and the ridge is arranged to fittingly receive and surround the rim when the spoon is removably secured to the fork.

17. The combination eating utensil recited in claim 14 wherein the first handle includes a first aperture arranged proximate the first distal end, the second handle includes a second aperture arranged proximate the second distal end, and the first aperture is aligned with the second aperture when the spoon is removably secured to the fork.

18. A meal transport system comprising:
a bag adapted to store food items therein;
a length of deformable of material attached to the bag; and,
a combination eating utensil comprising:
a spoon having a bowl extending from a first handle, wherein the first handle includes a first distal end arranged opposite the bowl and having an overhang, a first aperture arranged proximate the first distal end, and a first upper surface comprising a protuberance having a lip; and,
a fork having a plurality of tines extending from a second handle, wherein the second handle includes a second distal end arranged opposite the plurality of tines, a second aperture arranged proximate the second distal end, and a second upper surface comprising a member having a groove adapted to interlock with the lip, wherein the second distal end is adapted to be inserted underneath the overhang, and the spoon is pivotably connected to the fork when second distal end is inserted underneath the overhang, the spoon is removably secured to the second utensil when the groove is interlocked with the lip, the groove is arranged to pivot toward and interlock with the lip when the first utensil is pivotably connected to the second utensil, the first aperture is aligned with the second aperture when the spoon is removably secured to the fork, and the length of deformable material extends through the first aperture and the second aperture such that the combination eating utensil hangs from the bag.

19. The meal transport system recited in claim 18 wherein the second upper surface is concave and includes a rim, the first upper surface includes a perimeter and a ridge extending upwardly therefrom, and the ridge is arranged to fittingly receive and surround the rim when the spoon is removably secured to the fork.
